(19) United States
(12) Patent Application Publication
(10) Pub. No.: US 2005/0183480 A1
(43) Pub. Date: Aug. 25, 2005

(54) Electric lock

(76) Inventors: Neil Richard Hingston, Auckland (NZ); Matthew Richard Alex Nye-Hingston, Auckland (NZ)

Correspondence Address: YOUNG & THOMPSON, 745 SOUTH 23RD STREET, 2ND FLOOR, ARLINGTON, VA, 22202, US

(21) Appl. No.: 11/061,504

(22) Filed: Feb. 22, 2005

Related U.S. Application Data
(63) Continuation-in-part of application No. PCT/NZ03/00183, filed on Aug. 19, 2003.

(30) Foreign Application Priority Data
Aug. 19, 2002 (NZ) 520857

(51) Int. Cl. E05B 47/00

(52) U.S. Cl. 70/279.1

(57) ABSTRACT

An electric lock includes a bolt capable of being disposed in an extended, locked position and a retracted, unlocked position. The electric lock also includes an electric actuator for displacing the bolt between the locked and unlocked positions and latching elements to selectively latch the bolt in both the locked or unlocked positions. The electric lock can then be maintained in a locked state and in an alternatively unlocked state without requiring a continuous source of electrical or mechanical energy to maintain the lock in either state.

### TECHNICAL FIELD OF THE INVENTION

This invention relates to an electric and optionally manual lock. In particular, the invention relates to an electric and optional manual lock that can be maintained in a locked state and in an alternative unlocked state without requiring a continuous source of electrical or mechanical energy to maintain the lock in either state. The lock of the invention can be changed from the locked to the unlocked state and from the unlocked to the locked state either by the application of at least a pulse of electrical energy or by the operation of a manual mechanical means.

### BACKGROUND OF THE INVENTION

Electric locks are known which include a solenoid to actuate the bolt of the lock. The solenoid generally holds the lock in one position when the solenoid is actuated, and when the solenoid is not actuated i.e. when power is not applied to the solenoid, then a spring returns the lock to the other position. Locks for which power is supplied to the solenoid to move the lock bolt into a locked position are known as “power-to-lock” locks. Locks which are normally biased in the locked position, but require power to be applied to the solenoid to move the bolt to an unlocked position are referred to as “power-to-unlock” locks.

The primary disadvantage with these locks is that a power supply is required to maintain the lock in one state either locked or unlocked. This means that, in one state, power is continually being consumed by the apparatus, which is undesirable. It also means that if there is power failure, the lock may change to an undesired state. Depending upon the circumstances, this could merely be inconvenient, but it could also be potentially dangerous.

It is an object of the present invention to provide an electric and optionally manual lock or a method of operating an electric and optionally manual lock which will at least go some way toward overcoming the disadvantages of the prior art, or which will at least provide a useful alternative to known lock constructions.

### SUMMARY OF THE INVENTION

Accordingly in one aspect, the invention consists in an electric lock including
a bolt capable of being disposed in an extended, locked position and a retracted, unlocked position,
an electric actuator for displacing the bolt between the locked and unlocked positions, and latching means to selectively latch the bolt in both the locked or unlocked positions,
such that the lock can be maintained in a locked state and in an alternative unlocked state without requiring a continuous source of electrical or mechanical energy to maintain the lock in either state.

Preferably no power is required to maintain the lock in an unlocked and or locked position.

Preferably the lock can also be a manually operated lock.

Preferably the lock includes a mechanical actuator for displacing the bolt between the locked and unlocked positions.

Preferably an electronic system controls the lock functions.

Preferably the apparatus includes control means to provide at least a temporary supply, such as a pulse, of electric energy to the electric actuator to change the state of the bolt.

Preferably the latching means latch the electric actuator.

Preferably the latching means comprise magnetic latching means.

Preferably the electric actuator comprises a magnetically latched solenoid.

Preferably the solenoid includes a mechanical device such as a cylinder to operate the plunger to change the state of the lock from a locked to unlocked position and vice versa.

In a preferred form the apparatus includes a first detection means to detect when the bolt is in the locked position or the unlocked position.

Preferably a second detection means is also provided to detect when a door in which the lock is provided in use is in a closed position or an open position.

Preferably the detection means can be in the form of a reed switch.

In a further aspect the invention consists in a method of operating an electric lock having an electrically operated actuator and latching means to enable the lock to be disposed in a locked position or in an alternative unlocked position and vice versa, the method including the steps of
temporarily connecting the lock to a power supply in order to change the state of the lock from an unlocked position, to a locked position, and
temporarily connecting the lock to a power supply in order to change the state of the lock from a locked position to an unlocked position.

In a further aspect the invention consists in a method of operating an electric and manual lock having an electrically operated actuator and latching means to enable the lock to be disposed in a locked position or in an alternative unlocked position and vice versa, the method including the steps of
temporarily connecting the lock to a power supply in order to change the state of the lock from an unlocked position, to a locked position, and
temporarily connecting the lock to a power supply in order to change the state of the lock from a locked position to an unlocked position.

Preferably permanently connecting the lock to a power supply so that the lock is now controlled by the electronic control, and
temporarily connecting the electronic control in order to change the state of the lock from a locked to an unlocked position, automatically relocking is done by the electronic control.

Preferably the method includes the step of detecting whether the lock is in a locked or unlocked position.

Preferably the method further includes the step of detecting whether the door on which the lock is disposed in use is in a closed position or an open position.

Preferably the method includes an electronic control system that monitors both the lock and unlocked position of the bolt and also the open and closed position of the door.

Preferably the electronic control provides automatic re-lock when the door has been unlocked, opened and then closed.

Preferably the electronic control system provides timing of the lock to enable it to remain unlocked for time after receiving a request to exit signal from the control switch.

In a further aspect the invention consists of a method of operating an electrical and manual lock having a mechanically operated actuator and latching means to enable the lock to be disposed in a locked position or in an alternative unlocked position, the method including the steps of

Operation of a mechanical device, consisting of a cylinder, to operate the actuator to change the state of the lock from the locked to the unlocked position, or from the unlocked to the locked position and vice versa.

Preferably the mechanical lock can be either operated by fully electrical means or fully manual means or by a combination of both means.

### DRAWING DESCRIPTION

The invention consists of the foregoing and also envisages constructions of which the following gives examples only.

One presently preferred embodiment of the invention will now be described with reference to the accompanying drawings, wherein;

FIG. 1 is a partial diagrammatic side elevation of an electric lock with the lock bolt in an extended locked position

FIG. 2 is a side elevation of the lock assembly of FIG. 1 with the lock bolt shown in the retracted open position

FIG. 3 is a plan view of an electric lock according to the invention

FIG. 4 is a plan view of a strike plate for the lock of FIG. 3

FIG. 5 is a side elevation of the lock of FIG. 3 with the lock bolt in the locked position

FIG. 6 is a side elevation of the lock of FIGS. 3 and 5 but with the lock bolt in the unlocked position, and

FIG. 7 is a circuit diagram of an appropriate electric circuit for operation of the lock of the invention.

FIG. 8 is a partial diagrammatic side elevation of the lock, shown unlocked

FIG. 9 is a side elevation, with the lock bolt locked

FIG. 10 is an isometric view, with the lock bolt unlocked

FIG. 11 is an isometric view, with the lock bolt locked

FIG. 12 is a cross sectional side elevation, with the lock bolt unlocked

FIG. 13 is a cross sectional side elevation, with the lock bolt locked

FIG. 14 isometric cross sectional, with the lock bolt unlocked

FIG. 15 isometric cross sectional, with the lock bolt locked

FIG. 16 schematic view of the electric lock in an unassembled state.

FIG. 17 is a perspective view of a handle latching electrically operated lock.

FIG. 18 is a perspective view of a roller latching electrically operated lock.

### DESCRIPTION OF PREFERRED EMBODIMENTS

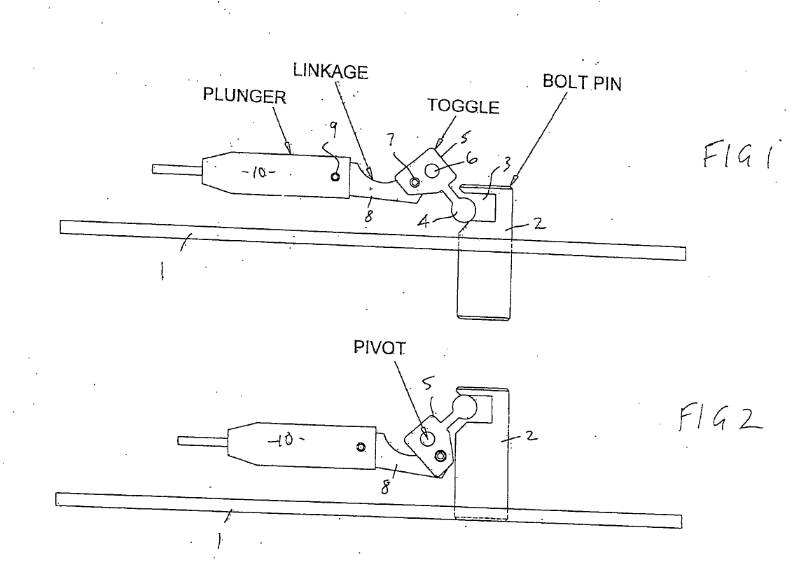

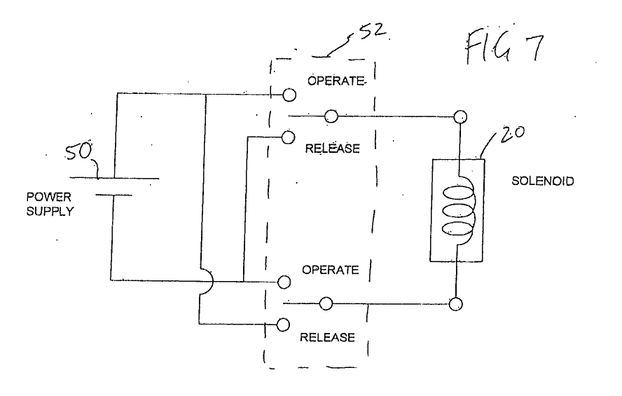

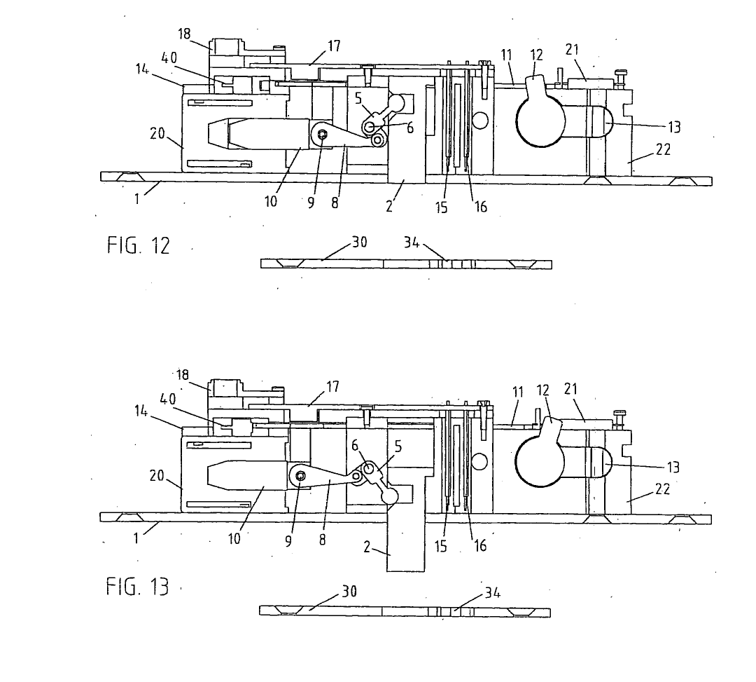

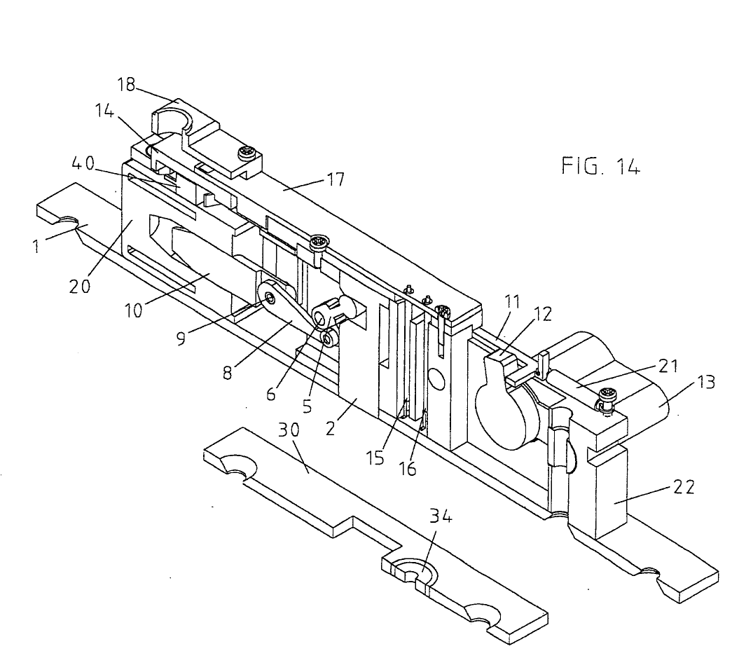

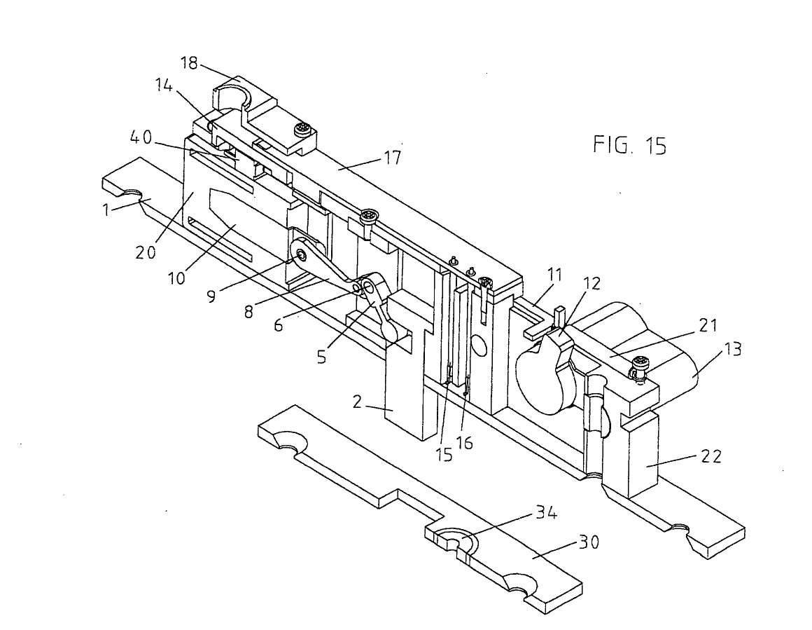

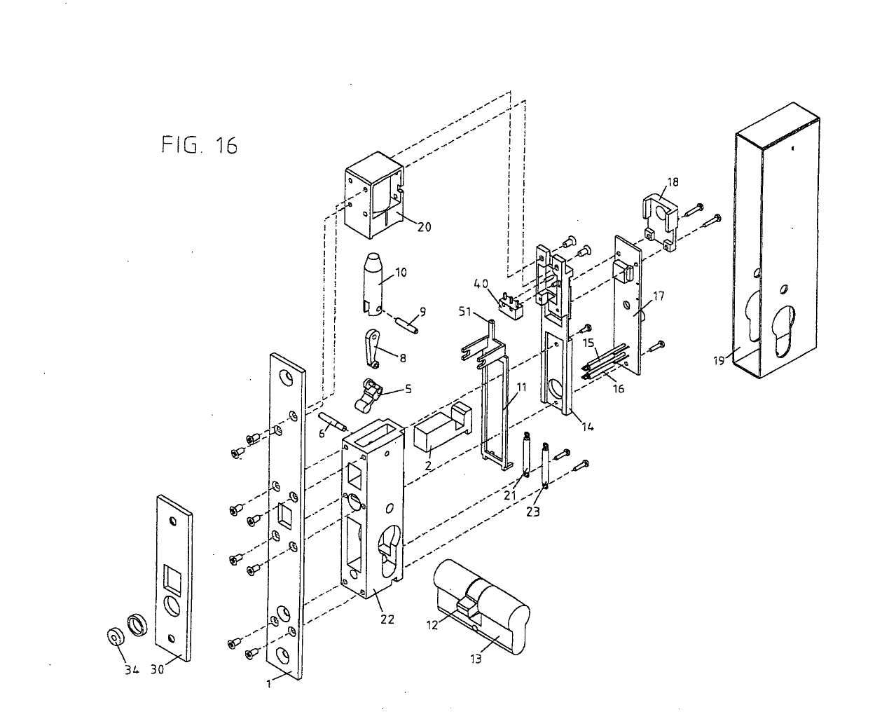

The basic assembly for an electric lock is illustrated in FIGS. 1-18 and labelled as per the schedule of parts on page 8 and 9. The assembly may be mounted on a plate or frame 1 which is in use disposed along an edge of a door or other wing element (for example a window) which may need to be locked relative to a frame (not shown). The lock has a bolt pin 2 which is usually constructed from a suitably robust material such as a solid steel (either round or rectangular). The bolt 2 is shown in FIGS. 1, 9, 11, 13 and 15 disposed in a position where it is extended from the plate 1 so as to enable it to extend through or into a strike plate (not shown) provided in use on a frame. When the bolt is in the extended position as shown in FIGS. 1, 9, 11, 13 and 15 a door on which the lock may be disposed will be locked relative to the frame.

The bolt has a contoured recess 3 which receives one end 4 of a toggle 5 which is mounted about a pivot 6. Although not shown in FIGS. 1, 9, 11, 13 and 15 the pivot 6 is held in a fixed position relative to the plate or frame 1. The toggle 5 also has a further pivot connection 7 which connects the toggle to a linkage 8 that is pivotally connected at its other end 9 to a plunger 10.

A solenoid actuator 20 in FIGS. 5, 6, 12, 13-15 in use receives plunger 10, which is constructed from a highly permeable magnetic material so that application of electric energy to the solenoid coil causes the plunger to be moved axially relative to the coil. In this way, the solenoid actuator can be used to move the linkage which in turn moves pivot point 7 relative to pivotal connection 6, causing end 4 of the toggle 5 to move through an arc, the ends of which describe locked and unlocked bolt positions. In FIGS. 1, 9, 11, 13 and 15 the plunger is shown in a position in which it would normally be retracted into the solenoid actuator, corresponding to a locked bolt position.

In FIGS. 2, 8, 10 and 12 the plunger is shown in a position in which it is partially expelled from the solenoid and this corresponds to the bolt being disposed in a retracted, unlocked position.

The solenoid plunger 10 and therefore the bolt pin 2 can also be positioned by manual methods as well as or alternatively. Referring to FIGS. 9 and 11, a cylinder 13 with a rotating tongue 12 is shown engaged in slider 11. The slider 11 is mechanically linked through pivot 9 to plunger 10 and then via linkage 8 and toggle 5 to bolt pin 2. As seen in FIGS. 9 and 11, tongue 12 is rotated counter clockwise to move slider 11, plunger 10, linkage 8, toggle 5 and bolt pin 2 to the extended locked position.

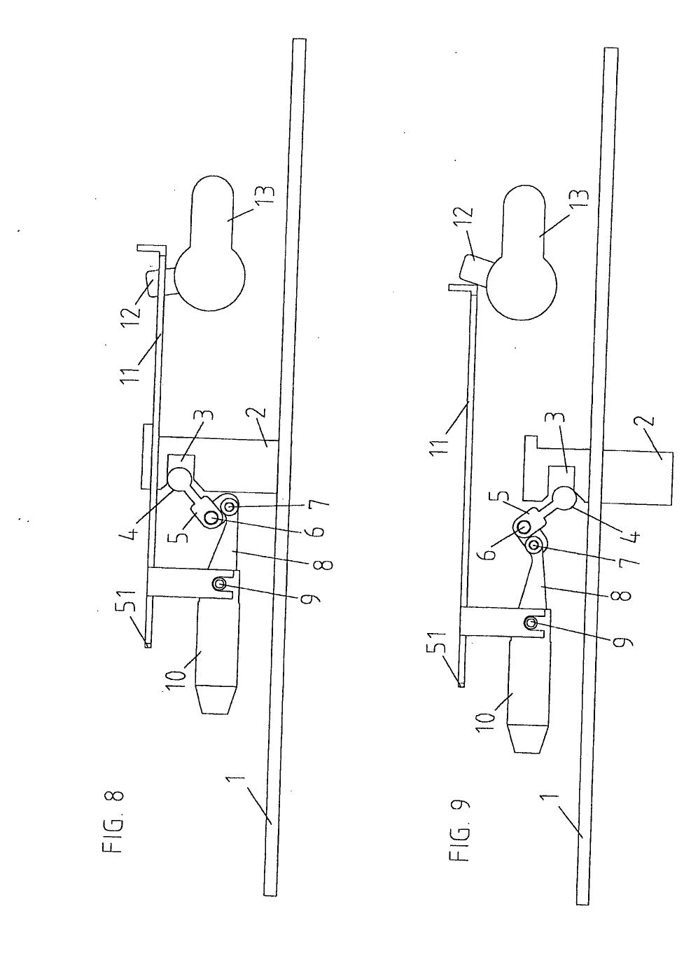

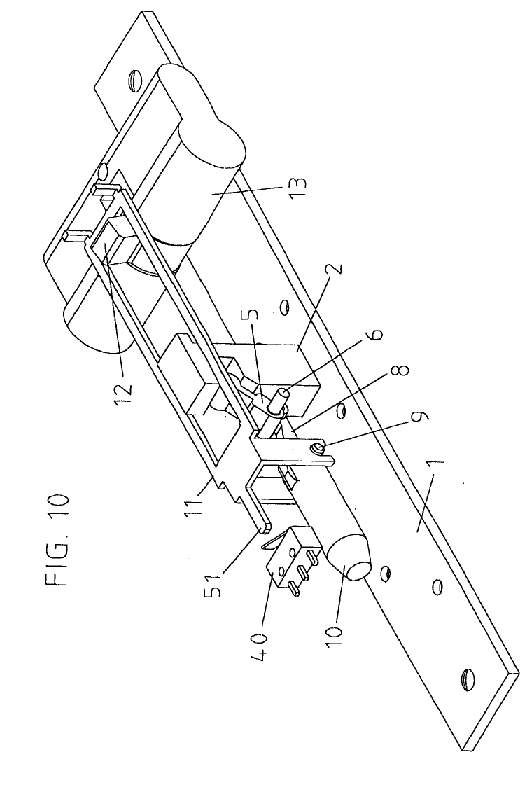

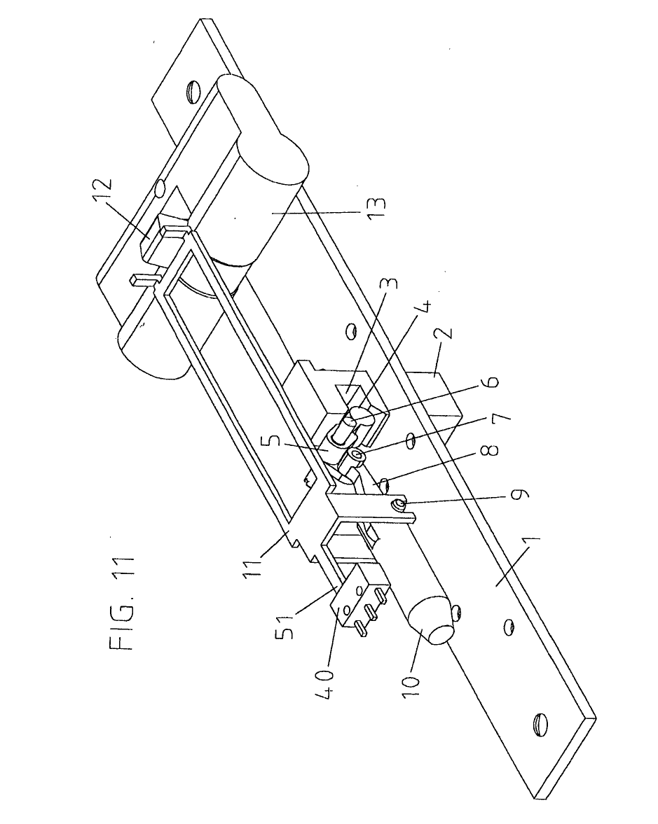

FIGS. 8 and 10 show tongue 12 of cylinder 13 rotated clockwise to move slider 11 into the unlocked position and the bolt pin 2 is shown retracted.

Turning now to FIG. 3, a plan view of the apparatus of FIG. 1, but further including a solenoid 20, and housing 22 for receiving the toggle and bolt assembly, is shown. The housing 22 preferably is constructed from a plastics material and is mounted on the plate 1, as is the solenoid 20. The housing 22 includes apertures 24 and 26, which are each adapted to receive a reed switch. In use, the reed switches which are located within cavities 24 and 26 are both activated in response to a sufficiently strong magnetic field of a certain orientation.

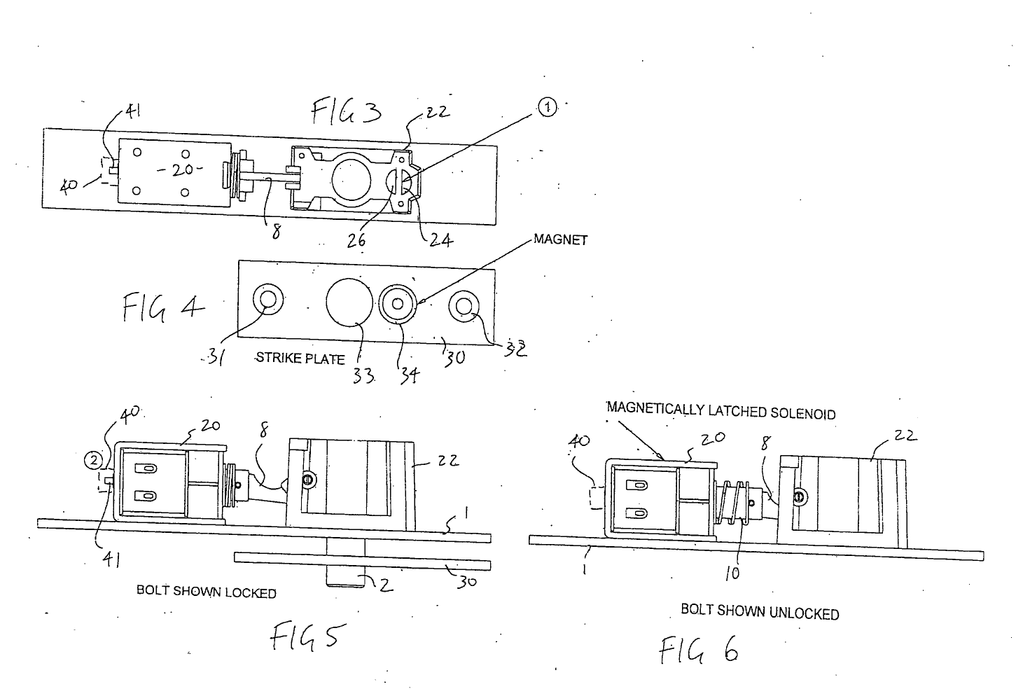

Referring now to FIG. 4, a strike plate 30, which is in use mounted on a door frame for example, is shown in plan view. The strike plate includes mounting apertures 31 and 32 for screws or similar fasteners to locate the strike plate and hold it in an appropriate orientation on the frame. The plate further includes a bolt receiving aperture 33 into or through which the bolt 2 projects in use when the bolt 2 is in the locked position. The face of the strike plate also includes a magnet 34. It is this magnet that activates the reed switches in cavities 24 and 26 when the door is in the closed position. The magnet is shown as being circular in FIG. 4, but those skilled will appreciate that the magnet may be provided in a variety of different forms or orientations and still be effective. Also, the magnet may be fastened to the strike plate in a number of different ways, or could even comprise a part of the strike plate.

In the preferred form, the magnet 34 is a rare earth magnet being in the order of approximately 10 mm in diameter and some 3 mm long. Such a rare earth magnet has been found to have a sufficiently strong field to ensure that the reed switches provided in cavities 24 and 26 are activated when the bolt 2 of the lock shown in FIG. 3 is in a position capable of being received in aperture 33 of the strike plate. A ball switch or micro switch may be used instead of a reed switch to give door position monitoring.

Turning to FIG. 5, the lock of FIG. 3 is shown in side elevation and the strike plate 30 is also shown. As can be seen, the lock is in the locked position. In FIG. 11 the lock is shown in isometric view in the locked position. Also shown is a micro switch 40, in diagrammatic form, which is activated by a end 51 of the slider 11.

Turning now to FIG. 10, the lock of FIGS. 3 and 5 is again shown in side elevation, but this time in the unlocked position. It will be seen that the slider 11 is repositioned so that end 51 does not protrude to activate the micro switch 40.

In use, the microswitch 40 acts as a “door locked monitor”. Therefore, the lock of FIGS. 3, 5, 6, 10 and 11 has a number of electrical connections (not all shown) that include electrical connections to energise the electronic control 17, electrical connections to each of the reed switches provided in cavities 24 and 26, and electrical connections for the microswitch 40. Accordingly, an appropriate control system (not shown) that is in use provided remote from the bolt can monitor microswitch 40 to determine whether the bolt is disposed in a locked position or an unlocked position. Also, one of the reed switches in cavities 24 and 26 is used as a “door closed monitor”. Therefore, when this reed switch is closed, the control system knows that the door is in a position in which it is closed because the lock is provided directly adjacent to the strike plate 30.

The other reed switch maybe used to perform an automatic locking function. Therefore, when this second reed switch is activated, and the lock bolt is in an unlocked position, the control system energises the solenoid to move the lock bolt into the locked position.

The lock of the present invention includes a latching means. The latch may take a variety of forms, but in the preferred invention it preferably comprises a magnetic latch. This is conveniently provided as part of the solenoid. Therefore, the plunger 10 of the solenoid preferably has a magnetic pole of the same polarity at either end, and an opposite magnetic pole is provided at the end of the solenoid closest to the bolt. Therefore, the solenoid is essentially bi-stable between the two extreme positions corresponding to a locked or unlocked bolt position. This means that a pulse of electrical energy from a power supply of a first polarity may be used to change the position of the plunger from that of an unlocked state to a locked state. A pulse of energy from the power supply of a second opposite polarity may be used to shift the lock to the opposite state. This has the significant advantage that the solenoid does not need to be continually energised or powered in order to retain the lock in a certain position. Also the electric lock does not require or need power to maintain the locked or unlocked position.

Another advantage with the latching arrangement of the present invention is that the bolt pin does not have to rely solely upon biasing means or a spring to return the bolt to an unlocked position. This is because the solenoid may be used to drive the bolt out of the locked position using an operating pulse. This means that the bolt pin 2 is able to overcome some side loading, for example caused by friction between the bolt and the strike plate 33 which is a problem for conventional drop bolts.

Turning now to FIG. 7, an example of a driving circuit for the latch solenoid of the present invention is shown. A DC power supply 50 is provided together with an appropriate control switch 52. As can be seen, switch 52 can be disposed in a first position to connect the power supply 50 to the solenoid 20 in a first polarity configuration, and the switch can be displaced in another orientation to reverse the polarity of the power supply 50 as applied to the solenoid. The lock includes an optional electronic control 17, which is an electronic version of the switching circuit shown in FIG. 7. In addition to reversing the polarity to the solenoid 20, it also is connected to reed switch 15 and is therefore able to monitor the closed or open status of the door that the lock is fitted into. This allows the electronic control 17 to provide a locking pulse of electrical power to the solenoid, to lock the door automatically when it is closed.

The invention provides significant advantages over and above the prior art, and those skilled in the art will appreciate that a number of different latching mechanisms may be used to implement the invention.

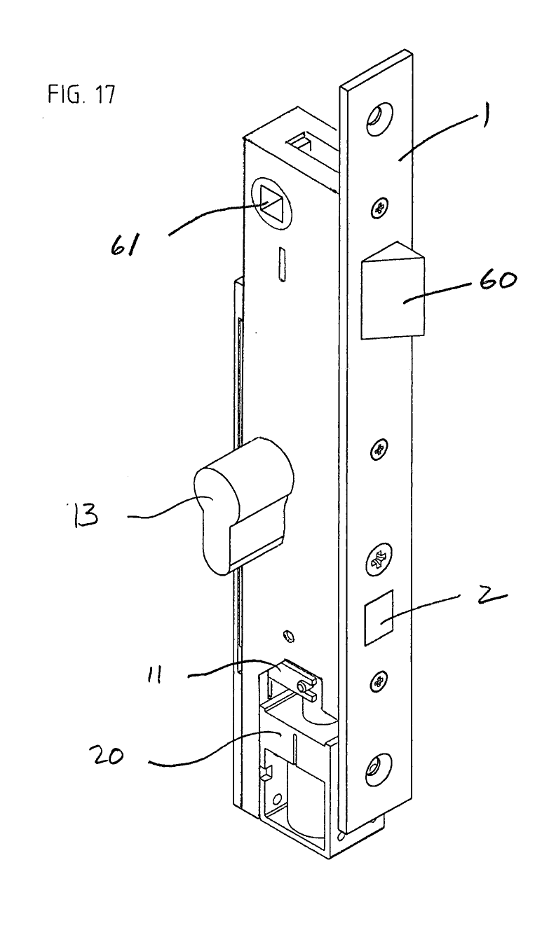

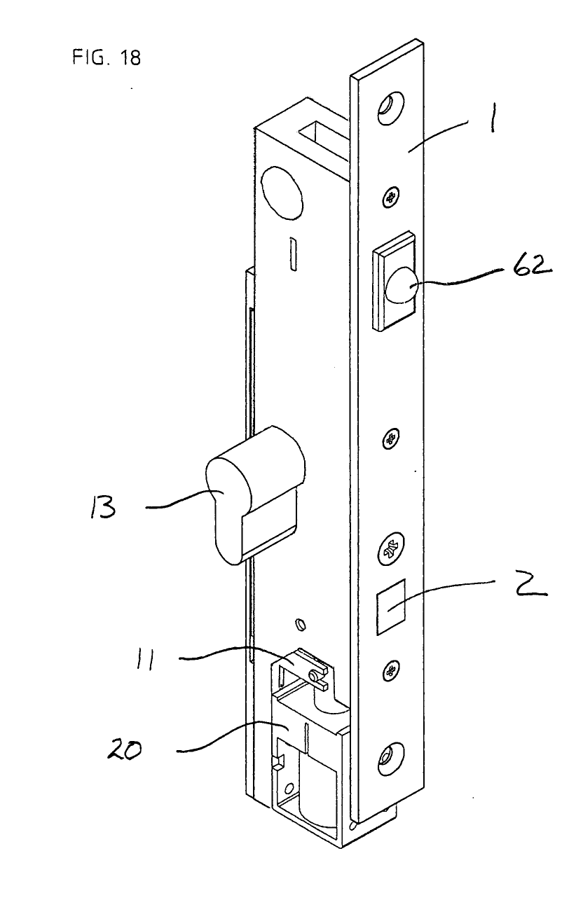

As shown in FIGS. 17 and 18 the lock can optionally include a manual operating means to open or close the wing element (door etc). For example a traditional biasedly attached latch 60 which can be operated by any type of handle via a polygonal shaft, in a complementary aperture 61 (eg square cross-section). Alternatively the latching means can have no handle such as with a roller latching means 62.

Throughout the description and claims of this specification the word “comprise” and variations of that word, such as “comprises” and “comprising”, are not intended to exclude other additives, components, integers or steps.

### SCHEDULE OF PARTS

1. Face plate
2. Bolt pin
5. Toggle
6. Pivot
8. Linkage
9. Pivot
10. Plunger
11. Slider
12. Lock tongue
13. Cylinder
14. Slider cap
15. Reed Switch
16. Reed Switch
17. Electronic control
18. Cable clamp
19. Cover
20. Solenoid
21. Spring
22. Housing
23. Spring
30 Strike plate
34. Magnet
40. Micro switch

1. An electric lock comprising the invention consisting in an electric lock including
a bolt capable of being disposed in an extended, locked position and a retracted, unlocked position,
an electric actuator for displacing the bolt between the locked and unlocked positions, and
latching means to selectively latch the bolt in both the locked or unlocked positions,
such that the lock can be maintained in a locked state and in an alternative unlocked state without requiring a continuous source of electrical or mechanical energy to maintain the lock in either state.

2. An electric lock as claimed in claim 1 wherein no power is required to maintain the lock in an unlocked and or locked position.

3. An electric lock as claimed in claim 2 wherein the lock can also be a manually operated lock.

4. An electric lock as claimed in claim 3 wherein there is proceeded a mechanical actuator for displacing the bolt between the locked and unlocked positions.

5. An electric lock as claimed in 4 wherein an electronic system controls the lock functions.

6. An electric lock as claimed in claim 5 wherein the lock includes control means to provide at least a temporary supply, such as a pulse, of electric energy to the electric actuator to change the state of the bolt.

7. An electric lock as claimed in claim 6 wherein the latching means latch the electric actuator.

8. An electric lock as claimed in claim 7 wherein the latching means comprise magnetic latching means.

9. An electric lock as claimed in claim 8 wherein the electric actuator comprises a magnetically latched solenoid.

10. An electric lock as claimed in claim 9 wherein the solenoid includes a mechanical device such as a cylinder to operate the plunger to change the state of the lock from a locked to unlocked position and vice versa.

11. An electric lock as claimed in claim 10 wherein the apparatus includes a first detection means to detect when the bolt is in the locked position or the unlocked position.

12. An electric lock as claimed in claim 11 wherein a second detection means is also provided to detect when a door in which the lock is provided in use is in a closed position or an open position.

13. An electric lock as claimed in claim 12 wherein the detection means can be in the form of a reed switch.

14. An electric lock as claimed in claim 13 wherein the lock is provided with a latching means which is manually operable.

15. An electric lock as claimed in claim 14 wherein the latching means can be a biazed attached latch or a roller means.

16. An electric lock as claimed in claim 15 wherein the lock is provided with a handle to operate the latching means.

17. A method of operating an electric lock having an electrically operated actuator and latching means to enable the lock to be disposed in a locked position or in an alternative unlocked position and vice versa, the method including the steps of:
temporarily connecting the lock to a power supply in order to change the state of the lock from an unlocked position, to a locked position, and
temporarily connecting the lock to a power supply in order to change the state of the lock from a locked position to an unlocked position.

18. A method of operating an electric and manual lock having an electrically operated actuator and latching means to enable the lock to be disposed in a locked position or in an alternative unlocked position and vice versa, the method including the steps of:
temporarily connecting the lock to a power supply in order to change the state of the lock from an unlocked position, to a locked position, and
temporarily connecting the lock to a power supply in order to change the state of the lock from a locked position to an unlocked position.

19. A method as claimed in claim 18 wherein the method further includes permanently connecting the lock to a power supply so that the lock is now controlled by the electronic control, and
temporarily connecting the electronic control in order to change the state of the lock from a locked to an unlocked position, automatically re-locking is done by the electronic control.

20. A method as claimed in claim 19 wherein the method includes the step of detecting whether the lock is in a locked or unlocked position.

21. A method as claimed in claim 20 wherein the method which further includes the step of detecting whether the door on which the lock is disposed in use is in a closed position or an open position.

22. A method as claimed in claim 21 wherein the method which includes an electronic control system that monitors both the lock and unlocked position of the bolt and also the open and closed position of the door.

23. A method as claimed in claim 22 wherein the electronic control provides automatic re-lock when the door has been unlocked, opened and then closed.

24. A method as claimed in claim 23 wherein the electronic control system provides timing of the lock to enable it to remain unlocked for time after receiving a request to exit signal from the control switch.

25. A method as claimed in claim 24 wherein the lock is provided with a latching means which is manually operable.

26. A method as claimed in claim 25 wherein the latching means can be a biazed attached latch or a roller means.

27. A method as claimed in claim 26 wherein the lock is provided with a handle to operate the latching means.

28. A method of operating an electrical and manual lock having a mechanically operated actuator and latching means to enable the lock to be disposed in a locked position or in an alternative unlocked position, the method including the steps of:
operation of a mechanical device, consisting of a cylinder, to operate the actuator to change the state of the lock from the locked to the unlocked position, or from the unlocked to the locked position and vice versa.

29. A method as claimed in claim 25 wherein the mechanical lock can be either operated by fully electrical means or fully manual means or by a combination of both means.
